(19) United States
(12) Patent Application Publication
(10) Pub. No.: US 2020/0077629 A1
(43) Pub. Date: Mar. 12, 2020

(54) CULTIVATION DEVICE, CULTIVATION SYSTEM, AND CULTIVATION METHOD

(71) Applicant: MITSUBISHI ELECTRIC CORPORATION, Tokyo (JP)

(72) Inventors: Tai Tanaka, Tokyo (JP); Hidetoshi Makimura, Tokyo (JP); Momoyo Hino, Tokyo (JP); Takeshi Okada, Tokyo (JP); Satoru Tanaka, Tokyo (JP); Yukihiro Tahara, Tokyo (JP)

(73) Assignee: MITSUBISHI ELECTRIC CORPORATION, Tokyo (JP)

(21) Appl. No.: 16/493,620

(22) PCT Filed: Apr. 26, 2017
(86) PCT No.: PCT/JP2017/016579

§ 371 Date: Sep. 12, 2019

(51) Int. Cl. A01K 61/60; A01K 61/10

(52) U.S. Cl. CPC A01K 61/60; A01K 61/10

(57) ABSTRACT

On the basis of monitoring information acquired by a monitoring device (4), a control device (6) determines a capacity and a position of a net (3), a winding device (2) adjusts the capacity of the net (3) to the capacity determined by the control device (6), and an underwater moving device (5) moves the net (3) to the position determined by the control device (6).

### TECHNICAL FIELD

The present invention relates to a cultivation device, a cultivation system, and a cultivation method for cultivating fish.

### BACKGROUND ART

Net cages are known as a cage used for fish cultivation. The net cages are cages in each of which a container for containing fish is constituted by a net, and the net cages are installed, for example, in a pond, a lake, a river, or a coastal area of the sea. The fish contained in the container are prevented by the net from escaping from the container, but can freely swim in the container. However, there are first to third problems in a normal cage as described below.

The first problem is a problem of a space for containing fish. Containing large fish requires a container large enough to contain the large fish. However, coastal areas of the sea are used for various purposes in addition to cultivation, and many fish and shellfish have already been cultivated in those areas. Under such circumstances, there is a limit to increase the size of the container.

The second problem is a problem related to damages to the environment caused by cages. For example, in a net cage, fish are contained in a container compartmented by a net, so that the density of organic substances such as feed or fish discharge inside the container is significantly higher than outside. There is a concern that such an increase in organic substances may adversely affect the environment outside the container, for example, may cause eutrophication.

In addition, organic substances deposited on and around the water bottom of such a cage are oxidatively decomposed by microorganisms to consume a large amount of oxygen. This may cause poor oxygenation at and around the water bottom.

The third problem is a problem regarding feed. Generally, when cultivating large fish, it is necessary to prepare small fish and shellfish as feed. However, because the catch of small fish and shellfish is limited, it is necessary to cultivate a large amount of fish and shellfish for feed, and, as a result, there occurs an increase in cost, which is problematic.

In dealing with these problems, for example, an underwater navigation robot described in Patent Literature 1 cultivates a shoal of fish while guiding the fish. Because a cultivation site is shifted, there is no need to consider a space for containing cultivated fish, and no organic substance such as the discharge of the cultivated fish is deposited.

In addition, the fish guided by the underwater navigation robot can capture small natural fish in addition to feed, so that it is not necessary to cultivate a large amount of fish and shellfish for feed.

### CITATION LIST

### Patent Literatures

Patent Literature 1: Japanese Patent Application Laid-open No. 63-273427

### SUMMARY OF INVENTION

### Technical Problem

However, in cultivation using the underwater navigation robot described in

Patent Literature 1, when the guidance of the fish is stopped, the fish escape from the cultivation site. For this reason, it is necessary to prepare a large container and to guide the fish in the container, or to constantly continue the guidance of the fish.

The preparation of such a large container is difficult to achieve as described above as the first problem. In addition, it is not practical for the underwater navigation robot to constantly guide fish from the viewpoint of supplying power to the robot.

The present invention solves the above-mentioned problems, and it is an object of the present invention to obtain a cultivation device, a cultivation system, and a cultivation method capable of adjusting the capacity of a container for containing fish to be cultivated and shifting a cultivation site.

### Solution to Problem

The cultivation device according to the present invention includes a container to contain fish under water, a capacity adjustment device to adjust a capacity of the container, an underwater moving device to move the container under water, a monitoring device to acquire monitoring information indicating internal and external states of the container, and a control device to control the capacity adjustment device and the underwater moving device. In this configuration, the control device determines a capacity and a position of the container on the basis of the monitoring information acquired by the monitoring device, the capacity adjustment device adjusts the capacity of the container to the capacity determined by the control device, and the underwater moving device moves the container to the position determined by the control device.

### Advantageous Effects of Invention

According to the present invention, it is possible to adjust the capacity of the container and to shift the cultivation site on the basis of the internal and external states of the container that contains the fish to be cultivated.

### BRIEF DESCRIPTION OF DRAWINGS

FIG. 1 is a view illustrating a configuration of a main part of a cultivation device according to a first embodiment of the present invention.

FIG. 2 is a block diagram illustrating a functional configuration of the cultivation device according to the first embodiment.

FIG. 3 is a view illustrating an example configuration of a container in the first embodiment.

FIG. 4A is a block diagram illustrating a hardware configuration for executing functions of the cultivation device according to the first embodiment. FIG. 4B is a block diagram illustrating a hardware configuration for executing software that executes functions of the cultivation device according to the first embodiment.

FIG. 5 is a flowchart illustrating a cultivation method according to the first embodiment.

FIG. 6 is a view illustrating another configuration of the container in the first embodiment.

FIG. 7 is a view illustrating a configuration of a main part of a cultivation system according to a second embodiment of the present invention.

FIG. 8 is a block diagram illustrating a functional configuration of the cultivation system according to the second embodiment.

### DESCRIPTION OF EMBODIMENTS

Hereinafter, in order to describe the present invention in more detail, embodiments of the present invention will be described with reference to the attached drawings.

First Embodiment.

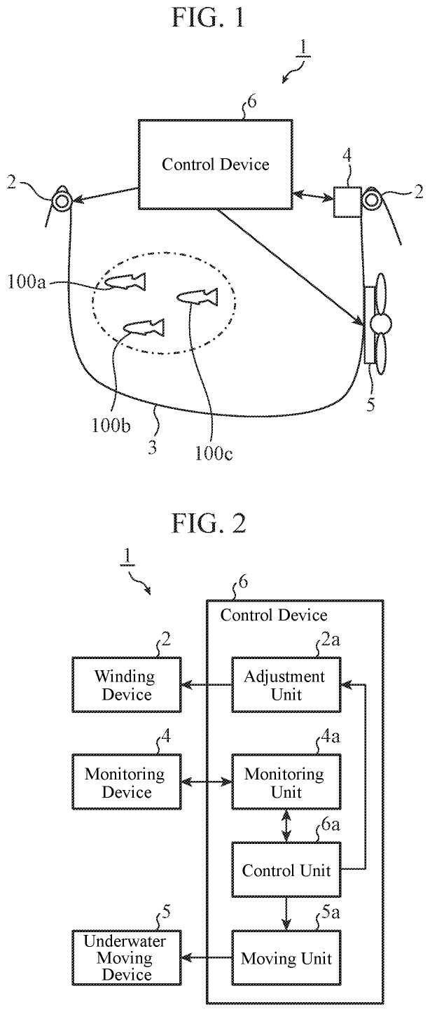

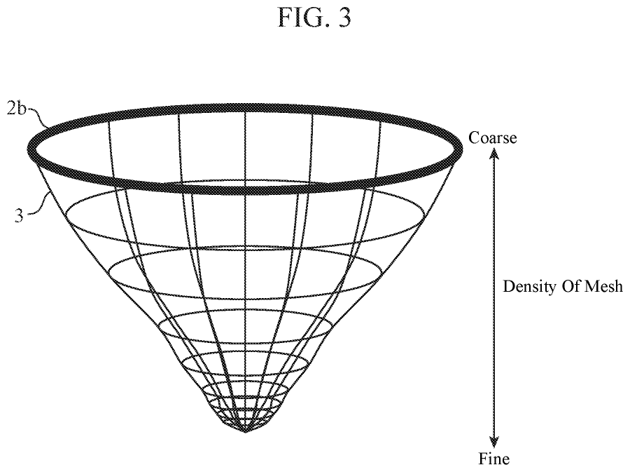

FIG. 1 is a view illustrating a configuration of a main part of a cultivation device 1 according to a first embodiment of the present invention. FIG. 2 is a block diagram illustrating a functional configuration of the cultivation device 1. FIG. 3 is a view illustrating an example configuration of a container in the first embodiment, and illustrates a net container.

As illustrated in FIG. 1, the cultivation device 1 is a device that cultivates fish, and includes a winding device 2, a container 3, a monitoring device 4, an underwater moving device 5, and a control device 6. Hereinafter, fish to be cultivated are described as cultivated fish 100a to 100c.

The winding device 2 is a capacity adjustment device that adjusts the capacity of the container 3 by winding the container 3. For example, the winding device 2 includes a winding-up unit 2b illustrated in FIG. 3.

The winding-up unit 2b is connected to an end on an upper side of the container 3 and gradually winds up the container 3 from the upper side. The container 3 is a net in a shape tapering from an upper side toward a lower side of the net, and is configured so that the capacity of the net remaining under water is gradually decreased as the net is wound up from the upper side by the winding-up unit 2b.

In addition, the container 3 is a net for containing the cultivated fish 100a to 100c, and, as illustrated in FIG. 3, is configured so that a mesh density of the net gradually increases from the upper side toward a bottom side of the net.

That is, as the capacity of the container 3 decreases, the mesh of the container 3 gradually becomes finer.

The finest mesh of the container 3 is sized so that fry of cultivated fish cannot pass through the mesh.

The capacity of the container 3 may be increased depending on growth of the cultivated fish by unwinding the container 3 wounded by the winding device 2. At that time, the capacity of the container 3 is changed to a capacity corresponding to the size of the mesh through which grown cultivated fish cannot pass. This eliminates need to form the whole net with a fine mesh, and the net can be obtained with a small amount of material.

The monitoring device 4 is a device that acquires monitoring information indicating the internal and external states of the container 3, and includes a sensor group for acquiring the monitoring information. The monitoring information includes information such as water temperatures inside and outside the container 3, the amounts of carbon dioxide inside and outside the container 3, the depth of the container 3 from the water surface, the current position of the container 3, growing conditions of the cultivated fish, and the presence or absence of a living organism acting as an external enemy of the cultivated fish. The sensor group includes, for example, various sensors, a global positioning system (GPS) device, and a camera. The various sensors detect water temperatures, carbon dioxide amounts, water depths, and the like. The GPS device detects the position of the container 3. The camera shoots cultivated fish and a living organism acting as an external enemy thereof.

The underwater moving device 5 is a device that moves the container 3 under water, and includes, for example, a motor and a screw as illustrated in FIG. 1. It is satisfactory as long as the underwater moving device 5 includes a propulsion mechanism that can move the container under water, and besides the screw, water jet propulsion may be adopted. In addition, the underwater moving device 5 may not only move the container 3 horizontally but also move the container 3 in the depth direction.

The control device 6 is a device that controls the winding device 2 and the underwater moving device 5 on the basis of the monitoring information acquired by the monitoring device 4. As illustrated in FIG. 2, the control device 6 includes an adjustment unit 2a, a monitoring unit 4a, a moving unit 5a, and a control unit 6a.

The adjustment unit 2a controls an operation of the winding device 2 so that a capacity determined by the control unit 6a is obtained. For example, table information in which capacities of the container 3 and respective winding amounts corresponding thereto are registered is stored in a memory (not illustrated). The adjustment unit 2a selects a winding amount corresponding to a capacity determined by the control unit 6a from the table information, and causes the winding device 2 to wind the container 3 by the selected winding amount.

The monitoring unit 4a transmits an information request to the monitoring device 4, receives the monitoring information acquired by the monitoring device 4 in accordance with the information request, and outputs the monitoring information received from the monitoring device 4 to the control unit 6a. The information request is periodically transmitted from the monitoring unit 4a to the monitoring device 4. At that time, the transmission interval of the information request may be changed depending on the content of the monitoring information.

For example, when a living organism acting as an external enemy of the cultivated fish is present, it is necessary to move the container 3 urgently to protect the cultivated fish from the living organism acting as an external enemy. Therefore, the monitoring unit 4a transmits, to the monitoring device 4 at short intervals, an information request for monitoring information on living organisms present in the vicinity of the container 3.

In addition, the monitoring unit 4a transmits, to the monitoring device 4 at relatively long intervals, an information request for monitoring information such as the water temperatures, the carbon dioxide amounts, and the growing conditions of the cultivated fish, the monitoring information being considered to show no sudden change.

The moving unit 5a controls the underwater moving device 5 in accordance with movement information acquired from the control unit 6a. The movement information is information indicating a movement position of the container 3 determined by the control unit 6a, and includes a relative distance and direction from the current position of the container 3 to a target position. The moving unit 5a generates a movement instruction for movement corresponding to the distance and the direction included in the movement information, and outputs the generated movement instruction to the underwater moving device 5. The underwater moving device 5 moves the container 3 to the target position in accordance with the movement instruction.

The control unit 6a determines an adjustment amount of the capacity of the container 3 on the basis of the monitoring information input from the monitoring unit 4a, and determines the movement information on the container 3. For example, when the current capacity of the container 3 is too small compared to a capacity of the container 3 suitable for a size and a behavioral range of the cultivated fish, the control unit 6a instructs the adjustment unit 2a to increase the capacity of the container 3. On the other hand, when the current capacity of the container 3 is too large, the control unit 6a instructs the adjustment unit 2a to decrease the capacity of the container 3.

In addition, the control unit 6a generates movement information including the relative distance and direction from the current position of the container 3 to the target position, and outputs the generated movement information to the moving unit 5a. The position of the container 3 is defined, for example, by position coordinates (latitude and longitude) of the container 3 and the depth thereof from the water surface.

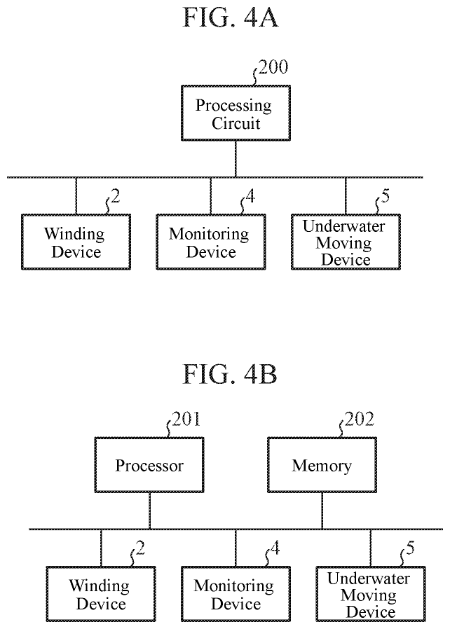

FIG. 4A is a block diagram illustrating a hardware configuration for executing functions of the cultivation device 1. In FIG. 4A, a processing circuit 200 is connected to the winding device 2, the monitoring device 4, and the underwater moving device 5. FIG. 4B is a block diagram illustrating a hardware configuration for executing software that executes the functions of the cultivation device 1. In FIG. 4B, a processor 201 and a memory 202 are connected to the winding device 2, the monitoring device 4, and the underwater moving device 5.

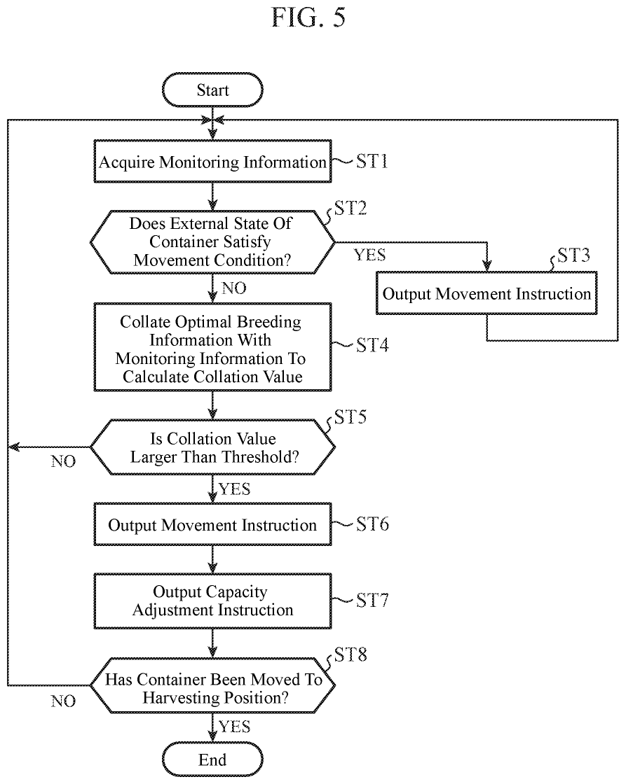

The functions of the adjustment unit 2a, the monitoring unit 4a, the moving unit 5a, and the control unit 6a in the cultivation device 1 is implemented by a processing circuit. That is, the cultivation device 1 includes the processing circuit for executing a series of processes from Step ST1 to Step ST8 illustrated in FIG. 5. The processing circuit may be dedicated hardware or a central processing unit (CPU) that executes a program stored in a memory.

When the processing circuit is dedicated hardware illustrated in FIG. 4A, the processing circuit 200 corresponds to, for example, a single circuit, a composite circuit, a programmed processor, a parallel programmed processor, an application specific integrated circuit (ASIC), a field programmable gate array (FPGA), or a combination thereof.

The functions of the adjustment unit 2a, the monitoring unit 4a, the moving unit 5a, and the control unit 6a may be implemented by separate processing circuits, or these functions may be implemented collectively by one processing circuit.

When the processing circuit is the processor 201 illustrated in FIG. 4B, the functions of the adjustment unit 2a, the monitoring unit 4a, the moving unit 5a, and the control unit 6a is implemented by software, firmware, or a combination of software and firmware. The software or firmware is described as programs and stored in the memory 202.

The processor 201 implements the functions of the respective units by reading and executing the programs stored in the memory 202. That is, the cultivation device 1 includes the memory 202 for storing programs which, when executed by the processor 201, result in execution of the series of processes from Step ST1 to Step ST8 illustrated in FIG. 5.

These programs cause a computer to execute procedures or methods of the adjustment unit 2a, the monitoring unit 4a, the moving unit 5a, and the control unit 6a.

The memory 202 corresponds to, for example, a non-volatile or volatile semiconductor memory such as a random access memory (RAM), a read only memory (ROM), a flash memory, an erasable programmable read only memory (EPROM), or an electrically EPROM (EEPROM), a magnetic disk, a flexible disk, an optical disk, a compact disc, a mini disk, or a DVD.

Some of the functions of the adjustment unit 2a, the monitoring unit 4a, the moving unit 5a, and the control unit 6a may be implemented by dedicated hardware, and some of the functions may be implemented by software or firmware.

For example, the functions of the adjustment unit 2a, the monitoring unit 4a, and the moving unit 5a may be implemented by the processing circuit 200 as dedicated hardware, and the function of the control unit 6a may be implemented by the processor 201 reading and executing the program stored in the memory 202.

Thus, the processing circuit can implement the above functions by hardware, software, firmware, or a combination thereof.

Next, an operation will be described.

FIG. 5 is a flowchart illustrating a cultivation method according to the first embodiment.

The monitoring unit 4a acquires monitoring information indicating internal and external states of the container 3 from the monitoring device 4 (Step ST1). The monitoring information acquired by the monitoring unit 4a is output to the control unit 6a.

The control unit 6a determines whether the external state of the container 3 satisfies a movement condition on the basis of the monitoring information input from the monitoring unit 4a (Step ST2). The movement condition indicates a state or an object that the container 3 should avoid urgently, and examples thereof may include worsening weather, the approach of another ship, and a living organism acting as an external enemy of the cultivated fish.

When the control unit 6a determines that the external state of the container 3 satisfies the movement condition (Step ST2; YES), the control unit 6a notifies the moving unit 5a of a direction in which the state or the object to be avoided is present.

For example, the control unit 6a notifies the moving unit 5a of the direction in which a living organism acting as an external enemy is present, the direction in which another ship approaches, the direction in which the weather is worsening, and the like.

The moving unit 5a outputs, to the underwater moving device 5, a movement instruction for movement in a direction in which the state or the object notified from the control unit 6a is avoided (Step ST3). The underwater moving device 5 moves the container 3 in accordance with the movement instruction input from the moving unit 5a. Thereafter, the processing returns to the process of Step ST1.

On the other hand, when the control unit 6a determines that the external state of the container 3 does not satisfy the movement condition (Step ST2; NO), the control unit 6a collates optimum breeding information with the monitoring information to calculate a collation value (Step ST4). The optimum breeding information is information indicating a water temperature, depth, and a breeding site suitable for each of multiple growth stages of cultivated fish from fry to adult. The collation value is a value indicating a difference between the optimum breeding information and the monitoring information. Adopted as the collation value is, for example, least square error between a true value obtained by weighting each of the water temperature, the depth, and the position of the breeding site depending on their respective importance degrees, and a value obtained by weighting each of the current water temperature, the current depth, and the current position included in the monitoring information depending on their respective importance degrees.

Next, the control unit 6a determines whether the collation value calculated in Step ST4 is larger than a threshold (Step ST5). The threshold is a tolerance of the collation value by which a current cultivation environment is considered to be similar to an optimal breeding environment. When the collation value is equal to or less than the threshold, the current cultivation environment is determined to be similar to the optimum breeding environment, and when the collation value is larger than the threshold, the current cultivation environment is determined to be not similar to the optimum breeding environment.

When it is determined by the control unit 6a that the collation value is equal to or less than the threshold (Step ST5; NO), the processing returns to Step ST1 and the series of processes described above is repeated.

When the control unit 6a determines that the collation value is larger than the threshold (Step ST5; YES), the control unit 6a specifies a site (target position) suitable for breeding the cultivated fish, the site being included in the optimum breeding information, and calculates the relative distance and direction from the current position of the container 3 to the target position. The movement information including the calculated distance and direction is output from the control unit 6a to the moving unit 5a.

The moving unit 5a generates a movement instruction for movement corresponding to the distance and the direction included in the movement information, and outputs the generated movement instruction to the underwater moving device 5 (Step ST6). The underwater moving device 5 moves the container 3 to the site suitable for breeding the cultivated fish in accordance with the movement instruction.

After the container 3 is moved to the site suitable for breeding the cultivated fish, the control unit 6a specifies the size and the behavioral range of the cultivated fish on the basis of the monitoring information input from the monitoring unit 4a, and determines the capacity of the container 3 suitable for the specified size and behavioral range of the cultivated fish.

Next, when the difference between the determined capacity of the container 3 and the current capacity of the container 3 exceeds a threshold, the control unit 6a determines a capacity of the container 3 so that the difference is equal to or less than the threshold, and outputs capacity information indicating the determined capacity to the adjustment unit 2a. The adjustment unit 2a generates a capacity adjustment instruction for adjusting the capacity of the container 3 to the capacity included in the capacity information, and outputs the generated capacity adjustment instruction to the winding device 2 (Step ST7). The winding device 2 adjusts the capacity of the container 3 to a capacity corresponding to a breeding state of the cultivated fish in accordance with the capacity adjustment instruction.

The control unit 6a determines whether the site at which the movement has finished in Step ST6 is a harvesting position (Step ST8). When it is determined by the control unit 6a that the current position of the container 3 is not the harvesting position (Step ST8; NO), the processing returns to Step ST1 and the series of processes described above is repeated. When it is determined by the control unit 6a that the current position of the container 3 is the harvesting position (Step ST8; YES), it is considered that the cultivated fish have already been grown to a size large enough for harvest. Therefore, the processing of FIG. 5 ends.

The cultivation device 1 according to the first embodiment is installed in a lake, a river, or a coastal area of the sea, for example.

Then, the fry of the cultivated fish are released into the interior of the container 3. At that time, the mesh of the container 3 is so fine that the fry cannot pass through the mesh, and the capacity of the container 3 is adjusted to a capacity capable of ensuring a behavioral range in which the fly are appropriately bred. Thereafter, the control device 6 controls the winding device 2 and the underwater moving device 5 depending on the growth of the cultivated fish, and thereby the capacity of the container 3 is adjusted depending on the size and the behavioral range of the cultivated fish, and the container 3 is moved to a site suitable for breeding the cultivated fish.

Although the case has been described where the container for containing cultivated fish is a net, there is no limitation thereto. In the first embodiment, any container may be used as long as it can contain cultivated fish and can adjust its capacity, and a container with a configuration indicated below may be adopted, for example.

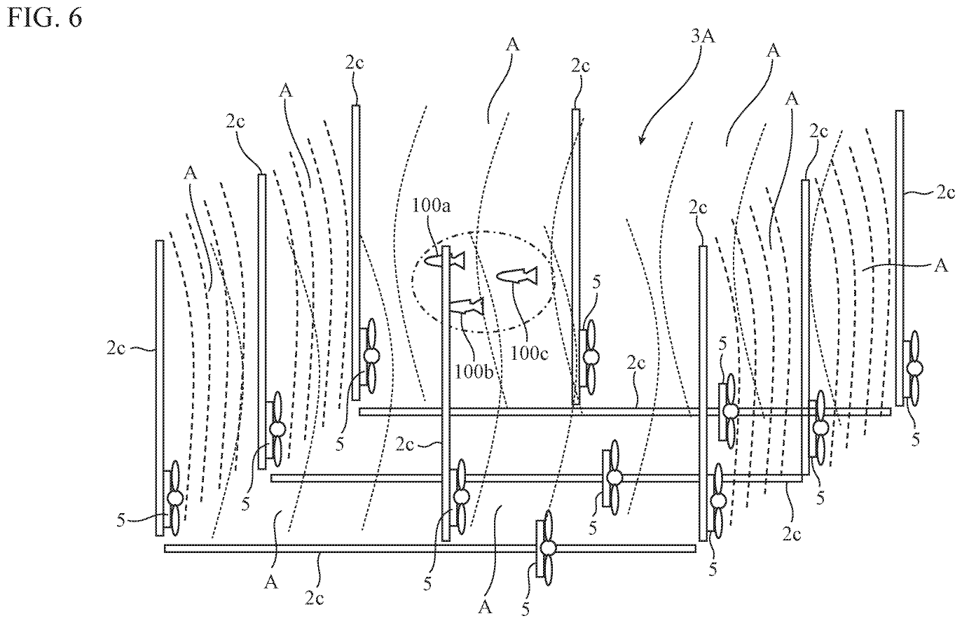

FIG. 6 is a view illustrating a configuration of a container 3A in the first embodiment. As illustrated in FIG. 6, the container 3A includes virtual wall surfaces A which restrict passage of the cultivated fish 100a to 100c by oscillatory waves propagated under water. The oscillatory waves are generated by rod-like oscillators 2c.

The adjacent oscillators 2c generate oscillatory waves toward each other, and thereby the wall surfaces A are formed between the adjacent oscillators 2c.

Although illustration of the wall surfaces A on upper and lower surfaces of the container 3A is omitted in FIG. 6, the wall surface A is provided on each of the upper and lower surfaces in addition to four side surfaces of the container 3A.

The underwater moving devices 5 illustrated in FIG. 1 are attached to the respective oscillators 2c.

The moving unit 5a generates a movement instruction in accordance with the movement information acquired from the control unit 6a, and outputs the generated movement instruction to the underwater moving devices 5. The underwater moving devices 5 move the container 3A to the target position while maintaining the formed wall surfaces A in accordance with the movement instruction.

The adjustment unit 2a generates a capacity adjustment instruction in accordance with the capacity information acquired from the control unit 6a, and outputs the generated capacity adjustment instruction to the underwater moving devices 5. The underwater moving devices 5 change the distance between the adjacent oscillators 2c so as to obtain a target capacity in accordance with the capacity adjustment instruction.

When the distance between the adjacent oscillators 2c is decreased, the wall surfaces A are reduced accordingly, and when the distance between the adjacent oscillators 2c is increased, the wall surfaces A are enlarged accordingly. That is, the underwater moving devices 5 function as a capacity adjustment device to adjust the capacity of the container 3A.

The distance between the adjacent oscillators 2c may be changed by a propulsion mechanism provided separately from the underwater moving devices 5.

As described above, the cultivation device 1 according to the first embodiment includes the winding device 2, the container 3 or the container 3A, the monitoring device 4, at least one of the underwater moving devices 5, and the control device 6. In this configuration, the control device 6 determines the capacity and the position of the container 3 or the container 3A on the basis of the monitoring information acquired by the monitoring device 4. The winding device 2 adjusts the capacity of the container 3 or the container 3A to the capacity determined by the control device 6, and the underwater moving device 5 moves the container 3 or the container 3A to the position determined by the control device 6.

Since the container 3 or the container 3A is moved as described above, the container 3 or the container 3A is not fixedly installed on a coastal area of the sea or the like. For this reason, the first problem described before is solved, and it is possible to further increase the capacity of the container 3 or the container 3A than ever before.

In addition, by moving the container 3 or the container 3A, an increase in the density of organic substances can be suppressed, so that the second problem described before is also solved.

Furthermore, in the container 3, the mesh restricts the escape of the cultivated fish 100a to 100c to the outside, but fish smaller than the mesh can enter the inside of the container 3 from the outside.

That is, the cultivated fish 100a to 100c can catch, separately from feed, small natural fish that have entered the inside of the container 3. As a result, it is not necessary to cultivate a large amount of fish and shellfish for feed, and an increase in cost can be suppressed, thereby solving the third problem described before as well.

In the cultivation device 1 according to the first embodiment, the container 3 is constituted by a net of which mesh becomes finer as it is wound up. The winding device 2 adjusts the capacity of the container 3 by winding the net container 3. With the above configuration, the capacity of the container 3 can be adjusted depending on the breeding state of the cultivated fish 100a to 100c.

In the cultivation device 1 according to the first embodiment, the container 3A is constituted by the virtual wall surfaces A that restrict the passage of fish by the oscillatory waves propagated under water. The underwater moving devices 5 adjust the capacity of the container 3A by enlarging and reducing the wall surfaces A in size. Also with this configuration, the capacity of the container 3A can be adjusted depending on the breeding state of the cultivated fish 100a to 100c.

Second Embodiment.

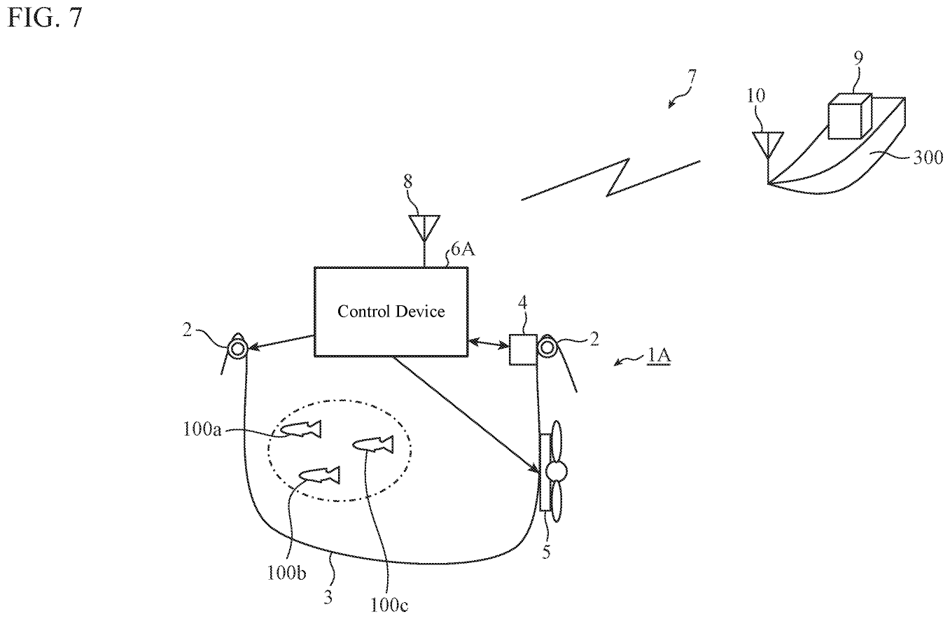

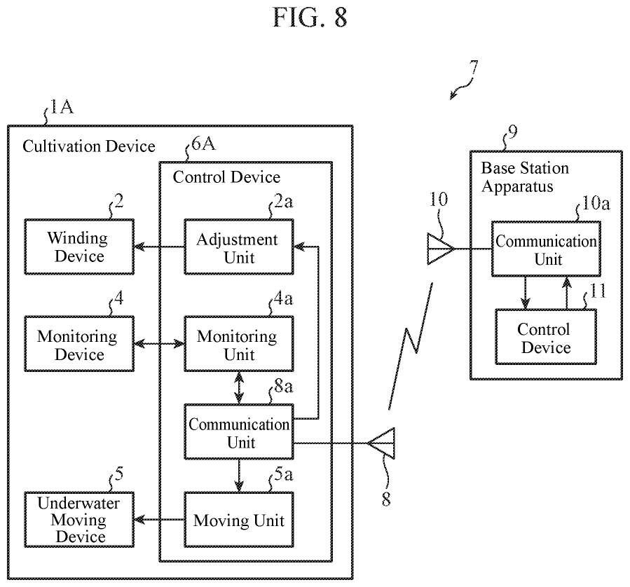

FIG. 7 is a view illustrating a configuration of a main part of a cultivation system 7 according to a second embodiment of the present invention. In FIG. 7, regarding same components as those in FIG. 1, same reference numerals are given thereto, and descriptions thereof will be omitted. FIG. 8 is a block diagram illustrating a functional configuration of the cultivation system 7. In FIG. 8, regarding same components as those in FIG. 2, same reference numerals are given thereto, and descriptions thereof will be omitted.

As illustrated in FIG. 7, the cultivation system 7 includes a cultivation device 1A and a base station apparatus 9.

The cultivation device 1A includes the winding device 2, the container 3, the monitoring device 4, the underwater moving device 5, a control device 6A, and an antenna 8. The base station apparatus 9 is mounted on a ship 300, and performs wireless communication with the cultivation device 1A using an antenna 10. The base station apparatus 9 may be installed on land.

The control device 6A includes the adjustment unit 2a, the monitoring unit 4a, the moving unit 5a, and a communication unit 8a, as illustrated in FIG. 8. By wireless communication using the antenna 8, the communication unit 8a transmits monitoring information acquired by the monitoring unit 4a to the base station apparatus 9, and receives, from the base station apparatus 9, movement information and capacity information which are control information. A first communication device that communicates with the base station apparatus 9 includes the antenna 8 and the communication unit 8a.

The adjustment unit 2a generates a capacity adjustment instruction for changing a capacity of the container 3 to a capacity included in the capacity information received by the communication unit 8a, and outputs the generated capacity adjustment instruction to the winding device 2. The winding device 2 adjusts the capacity of the container 3 to a capacity corresponding to a breeding state of cultivated fish in accordance with the capacity adjustment instruction.

The moving unit 5a generates a movement instruction for movement corresponding to a distance and a direction included in the movement information received by the communication unit 8a, and outputs the generated movement instruction to the underwater moving device 5. The underwater moving device 5 moves the container 3 to a target position in accordance with the movement instruction.

The base station apparatus 9 includes a communication unit 10a and a control device 11 as illustrated in FIG. 8.

By wireless communication using the antenna 10, the communication unit 10a transmits the movement information and the capacity information to the cultivation device 1A, and receives the monitoring information from the cultivation device 1A. A second communication device that communicates with the cultivation device 1A includes the antenna 10 and the communication unit 10a.

On the basis of the monitoring information received by the communication unit 10a, the control device 11 calculates capacity information on the container 3 and calculates movement information on the container 3. For example, similarly to the first embodiment, the control device 11 collates optimum breeding information with the monitoring information to calculate a collation value, and determines whether the collation value is larger than a threshold. When the collation value is larger than the threshold, the control device 11 calculates movement information and capacity information using the optimum breeding information. The movement information and the capacity information calculated by the control device 11 are transmitted to the cultivation device 1A by the communication unit 10a.

Although the case has been described where the communication unit 8a performs wireless communication with the base station apparatus 9 and the communication unit 10a performs wireless communication with the cultivation device 1A, the wireless communication may be substituted by wired communication.

In addition, because the propagation of radio waves is hindered under water, a radio receiver such as an antenna is exposed above the water surface when wireless communication is performed.

The base station apparatus 9 may include an information presentation device and an input device (not illustrated).

The information presentation device is a device that presents the monitoring information received by the communication unit 10a to an operator. For example, the information presentation device includes a monitor that displays the monitoring information.

The input device is a device that receives input of control information (capacity information and movement information) by the operator. For example, the operator can input the control information corresponding to the monitoring information to the base station apparatus 9 using the input device.

The control information received by the input device is transmitted to the cultivation device 1A by the communication unit 10a. The cultivation device 1A moves the container 3 and adjusts the capacity of the container 3 on the basis of the control information received by the communication unit 8a from the base station apparatus 9.

As described above, the cultivation system 7 according to the second embodiment includes the cultivation device 1A and the base station apparatus 9. The control device 11 of the base station apparatus 9 determines the capacity and the position of the container 3 on the basis of the monitoring information received by the communication unit 10a from the cultivation device 1A, and causes the communication unit 10a to transmit the capacity information and the movement information to the cultivation device 1A. The winding device 2 adjusts the capacity of the container 3 to the capacity determined by the control device 11, on the basis of the capacity information received by the communication unit 8a from the base station apparatus 9. The underwater moving device 5 moves the container 3 to the position determined by the base station apparatus 9, on the basis of the movement information received by the communication unit 8a from the base station apparatus 9.

With the above configuration, the capacity of the container 3 can be adjusted and a cultivation site can be shifted on the basis of the internal and external states of the container 3.

It should be noted that, in the present invention, each of the embodiments can be freely combined with another embodiment, any constituent element of each embodiment can be modified, or any constituent element can be omitted in each embodiment, within the scope of the invention.

### INDUSTRIAL APPLICABILITY

The cultivation device according to the present invention is capable of adjusting the capacity of a container for containing cultivated fish and shifting a cultivation site, and therefore, is suitable for cultivation of large fish such as tuna.

### REFERENCE SIGNS LIST

1, 1A: cultivation device, 2: winding device, 2a: adjustment unit, 2b: winding-up unit, 2c: oscillator, 3, 3A: container, 4: monitoring device, 4a: monitoring unit, 5: underwater moving device, 5a: moving unit, 6, 6A, 11: control device, 6a: control unit, 7: cultivation system, 8, 10: antenna, 8a, 10a: communication unit, 9: base station apparatus, 100a to 100c: cultivated fish, 200: processing circuit, 201: processor, 202: memory, 300: ship.

1. A cultivation device comprising:
a container to contain fish under water;
a capacity adjustment device to adjust a capacity of the container;
an underwater moving device to move the container under water;
a monitoring device to acquire monitoring information indicating internal and external states of the container; and
processing circuitry to control the capacity adjustment device and the underwater moving device, wherein
the processing circuitry determines a capacity and a position of the container on a basis of the monitoring information acquired by the monitoring device,
the capacity adjustment device adjusts the capacity of the container to the capacity determined by the processing circuitry, and
the underwater moving device moves the container to the position determined by the processing circuitry.

2. The cultivation device according to claim 1, wherein
the container includes a net of which mesh becomes finer as the net is wound up, and
the capacity adjustment device adjusts the capacity of the container by winding up the net.

3. The cultivation device according to claim 1, wherein
the container includes at least one virtual wall surface which restricts passage of the fish by oscillatory waves propagated under water, and
the capacity adjustment device adjusts the capacity of the container by enlarging and reducing the virtual wall surface in size.

4. An cultivation system comprising a cultivation device and a base station apparatus, the cultivation device including:
a container to contain fish under water;
a capacity adjustment device to adjust a capacity of the container;
an underwater moving device to move the container under water;
a monitoring device to acquire monitoring information indicating internal and external states of the container; and
a first communication antenna to communicate with the base station apparatus, and
the base station apparatus comprising:
a second communication antenna to communicate with the cultivation device; and
a processing circuitry to control the capacity adjustment device and the underwater moving device, wherein
the processing circuitry determines a capacity and a position of the container on a basis of the monitoring information received by the second communication antenna from the cultivation device, and causes the second communication antenna to transmit control information specifying the determined capacity and position to the cultivation device,
the capacity adjustment device adjusts the capacity of the container to the capacity determined by the processing circuitry, on a basis of the control information received by the first communication antenna from the base station apparatus, and
the underwater moving device moves the container to the position determined by the processing circuitry, on a basis of the control information received by the first communication antenna from the base station apparatus.

5. A cultivation method comprising:
containing fish in a container under water;
adjusting a capacity of the container;
moving the container under water;
acquiring monitoring information indicating internal and external states of the container; and
controlling capacity adjustment and movement of the container, wherein the method further comprises:
determining a capacity and a position of the container on a basis of the monitoring information acquired;
adjusting the capacity of the container to the capacity determined; and
moving device, moving the container to the position determined.
